(19) United States
(12) Patent Application Publication
(10) Pub. No.: US 2022/0395972 A1
(43) Pub. Date: Dec. 15, 2022

(54) POWER TOOL HAVING ROTARY HAMMER MECHANISM

(71) Applicant: MAKITA CORPORATION, Anjo-shi (JP)

(72) Inventors: Hitoshi IIDA, Anjo-shi (JP); Hikaru SUNABE, Anjo-shi (JP); Masanori FURUSAWA, Anjo-shi (JP)

(73) Assignee: MAKITA CORPORATION, Anjo-shi (JP)

(21) Appl. No.: 17/747,555

(22) Filed: May 18, 2022

(30) Foreign Application Priority Data
Jun. 10, 2021 (JP) 2021-097321

(51) Int. Cl. B25D 16/00

(52) U.S. Cl. CPC B25D 16/006; B25D 16/003; B25D 2216/0015; B25D 2216/0023; B25D 2216/0038; B25D 2216/0084; B25D 2250/221

(57) ABSTRACT

A power tool having a rotary hammer mechanism has a first motor; a driving mechanism configured to operate by power of the first motor in an action mode selected from a plurality of action modes including a first mode of at least rotationally driving a tool accessory and a second mode of only linearly driving the accessory; a tool holder configured to be rotationally driven by torque transmitted from the first motor; a second motor; a clutch member configured to transmit torque to the holder in a transmitting position and to interrupt the transmission in an interrupting position; and a transmitting mechanism configured to convert rotation of the second motor into linear motion and transmit the linear motion to the clutch member. When the tool body excessively rotates around the driving axis, the second motor moves the clutch member from the transmitting position via transmitting mechanism to interrupt the transmission.

### CROSS REFERENCE TO RELATED ART

The present application claims priority to Japanese Patent Application No. 2021-97321 filed on Jun. 10, 2021, the disclosure of which is hereby incorporated by reference in its entirety.

### TECHNICAL FIELD

The present disclosure relates to a power tool having a rotary hammer mechanism.

### BACKGROUND

Power tools having a rotary hammer mechanism are known. Such power tools are configured to operate according to a mode selected from a plurality of modes, including a mode of performing only hammering motion of linearly driving a tool accessory in a direction along a prescribed driving axis and a mode of performing at least rotating motion of rotationally driving the tool accessory around the driving axis. Japanese Patent No. 4340316 discloses a rotary hammer that is provided with a clutch member for changing an action mode and an operation member having an electric actuator for moving the clutch member.

In such power tools, the tool accessory may be jammed on a workpiece, which may cause excessive rotation (also referred to as kickback) of the tool body around a driving axis. Therefore, it has been desired to provide a power tool having a rotary hammer mechanism that is capable of coping with such excessive rotation of the tool body around the driving axis.

### SUMMARY

According to one aspect of the present disclosure, a power tool having a rotary hammer mechanism is provided. The power tool has a first motor that is housed in a tool body, a driving mechanism, a tool holder, a second motor, a clutch member and a transmitting mechanism. The driving mechanism is configured to operate by power of the first motor in an action mode that is selected from a plurality of action modes including a first mode of at least rotationally driving a tool accessory around a driving axis and a second mode of only linearly driving the tool accessory along the driving axis. The tool holder is configured to removably hold the tool accessory and to be rotationally driven around the driving axis by torque transmitted from the first motor. The clutch member is configured to be moved by power of the second motor. The clutch member is configured to be moved to a transmitting position where the clutch member enables torque transmission to the tool holder. The clutch member is also configured to be moved to an interrupting position where the clutch member interrupts the torque transmission to the tool holder. The transmitting mechanism is configured to convert rotation of the second motor into linear motion and transmit the linear motion to the clutch member. The second motor is configured to be driven to change the action mode of the driving mechanism to the first mode by moving the clutch member to the transmitting position via the transmitting mechanism. The second motor is also configured to be driven to change the action mode of the driving mechanism to the second mode by moving the clutch member to the interrupting position via the transmitting mechanism. The second motor is further configured to, when the tool body excessively rotates around the driving axis, be driven to move the clutch member from the transmitting position via the transmitting mechanism to thereby interrupt the torque transmission.

According to this aspect, the power tool having a rotary hammer mechanism is provided that can change the action mode of the driving mechanism by the transmitting mechanism converting rotation of the second motor into linear motion and transmitting it to the clutch member and moving the clutch member to the transmitting position where the clutch member enables torque transmission to the tool holder and to the interrupting position where the clutch member interrupts the torque transmission to the tool holder. Further, the second motor is configured to, when the tool body excessively rotates around the driving axis, be driven to move the clutch member via the transmitting mechanism to thereby interrupt the torque transmission. Thus, when the tool body excessively rotates around the driving axis, the rotation of the tool body is stopped. Therefore, according to this embodiment, the power tool can be provided in which the same second motor is used for change of the action mode and interruption of torque transmission so that the safety is enhanced.

### BRIEF DESCRIPTION OF THE DRAWINGS

FIG. 1 is a longitudinal section schematically showing a rotary hammer.

FIG. 2 is a partial, enlarged view of FIG. 1 in a hammer mode.

FIG. 3 is a top view showing a mode changing operation part and an indicating part.

FIG. 4 is a top view showing a connecting member and a lock lever in the hammer mode.

FIG. 5 is a partial, enlarged view corresponding to FIG. 2, showing the rotary hammer in a rotary hammer mode.

FIG. 6 is a top view corresponding to FIG. 4, showing the connecting member and the lock lever in the rotary hammer mode.

FIG. 7 is a partial, enlarged view corresponding to FIG. 2, showing the rotary hammer in a neutral mode.

FIG. 8 is a top view corresponding to FIG. 4, showing the connecting member and the lock lever in the neutral mode.

FIG. 9 is a sectional view taken along line IX-IX in FIG. 2, for illustrating a locking mechanism.

FIG. 10 is an enlarged, longitudinal section of the locking mechanism and its vicinity, for illustrating the locking mechanism and a switch lever in the hammer mode.

FIG. 11 is an enlarged, longitudinal section of the locking mechanism and its vicinity, for illustrating the locking mechanism and the switch lever in the rotary hammer mode.

### DETAILED DESCRIPTION OF THE EMBODIMENTS

In one non-limiting embodiment according to the present disclosure, the clutch member may be on the tool holder and configured to be movable along the driving axis. The transmitting position and the interrupting position may be different positions in a direction along the driving axis. Further, the transmitting mechanism may be configured to convert the rotation of the second motor into the linear motion along the driving axis and transmit the linear motion to the clutch member.

According to this embodiment, the rotation of the tool body can be stopped when the tool body excessively rotates around the driving axis. Further, the same second motor can be used for change of the action mode and interruption of torque transmission.

In addition or in the alternative to the preceding embodiments, the power tool may further have a rotation detecting part that is configured to detect a state of rotation of the tool body around the driving axis; and a controlling part that is configured to control driving of the first motor and the second motor. The controlling part may be configured to determine whether the tool body is excessively rotated around the driving axis based on a detection result of the rotation detecting part. Further, the controlling part may be configured to stop driving of the first motor and drive the second motor to move the clutch member from the transmitting position in response to determining that the tool body is excessively rotated around the driving axis.

According to this embodiment, the safety of the power tool can be further enhanced.

In addition or in the alternative to the preceding embodiments, the power tool may further have a mode detecting part. The mode detecting part may include a first detecting part configured to detect that the action mode of the driving mechanism is the first mode and a second detecting part configured to detect that the action mode of the driving mechanism is the second mode.

According to this embodiment, the power tool can be provided that is capable of detecting the action mode of the driving mechanism.

In addition or in the alternative to the preceding embodiments, the controlling part may be configured to stop the second motor based on a detection result of the mode detecting part.

According to this embodiment, the mode detecting part can be utilized to control the timing of stopping the second motor.

In addition or in the alternative to the preceding embodiments, the power tool (the tool body) may further have a stopper. The transmitting mechanism may include a first member. The first member may be operably coupled to the second motor and to the clutch member. The first member may be configured to be moved along the driving axis by the second motor. The stopper may be configured to position the clutch member in the transmitting position or in the interrupting position by interfering with the first member.

According to this embodiment, the accuracy of positioning the clutch member can be enhanced compared without the stopper.

In addition or in the alternative to the preceding embodiments, the first member may be configured to be movable in a first direction and a second direction opposite to the first direction in parallel to the driving axis. The stopper may have a first surface and a second surface that cross the moving direction of the first member. The first surface may be configured to position the clutch member in the transmitting position by interfering with the first member when the first member moves in the first direction. The second surface may be configured to position the clutch member in the interrupting position by interfering with the first member when the first member moves in the second direction.

According to this embodiment, the clutch member can be accurately positioned in the transmitting position and in the interrupting position by utilizing the first and second surfaces of the stopper.

In addition or in the alternative to the preceding embodiments, a rotational axis of the second motor may extend in a direction crossing the driving axis. The driving axis may extend through the second motor.

According to this embodiment, the second motor can be arranged close to the clutch member. Therefore, the transmitting mechanism can be formed compact, so that the power tool can be reduced in size.

In addition or in the alternative to the preceding embodiments, the transmitting mechanism may include a pinion gear and a rack gear. The pinion gear may be configured to be rotated by the second motor. The rack gear may be configured to be engaged with the pinion gear and convert rotation of the pinion gear into the linear motion along the driving axis.

According to this embodiment, the clutch member can be moved along the driving axis by converting rotation of the second motor into the linear motion along the driving axis via the pinion gear and the rack gear. Further, the conversion from the rotation to the linear motion can be easily achieved.

In addition or in the alternative to the preceding embodiments, the power tool having a hammer mechanism may further have a main operation member, a locking member and a lock controlling member. The main operation member may be configured to be normally held in an OFF position and to be moved to an ON position to drive the first motor when manually depressed by a user. The locking member may be configured to be moved to a lock position to lock the main operation member in the ON position or to a non-lock position not to lock the main operation member in the ON position, in response to the user's manual operation of the locking member. The lock controlling member may be configured to, in the first mode, be in a position to interfere with the locking member, thereby holding the locking member in the non-lock position. The lock controlling member may further be configured to, in the second mode, be in a position not to interfere with the locking member, thereby allowing the locking member to move to the lock position.

According to this embodiment, in the second mode in which the tool accessory performs hammering only motion, the lock controlling member is configured to allow the locking member to move to the lock position, so that the user need not keep manually depressing the main operation member during operation of continuously performing hammering only motion for a relatively long time. Thus, the burden on the user during the operation can be reduced. Further, in the first mode in which the tool accessory performs rotating motion, the lock controlling member holds the locking member in the non-lock position, so that the user can stop driving of the first motor simply by releasing the main operation member, for example, even if the tool accessory is jammed on the workpiece. Therefore, the power tool can be provided with high safety.

In addition or in the alternative to the preceding embodiments, the power tool may further have a handle, a rotation detecting part and an elastic member. The handle may have a grip part that extends in a direction crossing the driving axis and is configured to be held by a user. The elastic member may connect the handle to the tool body so as to be movable along the driving axis relative to the tool body. Further, the rotation detecting part may be housed within the handle.

According to this embodiment, the rotation detecting part is housed within the handle that is relatively movably connected to the tool body, so that transmission of vibration from the tool body to the rotation detecting part can be reduced. Thus, the life of the rotation detecting part can be prolonged.

In addition or in the alternative to the preceding embodiments, the rotary power tool having a hammer mechanism may further have a mode changing operation part. The mode changing operation part may be configured to be manually operated by a user to select the action mode of the driving mechanism. Further, the mode changing operation part may be an electronic switch that is arranged such that there is no gap between the electronic switch and an outer surface of the tool body.

According to this embodiment, the power tool can be provided that is configured to drive the second motor to change the action mode of the driving mechanism with the mode changing operation part. Further, the mode changing operation part is configured as an electronic switch for driving the second motor, so that the mode changing operation part can be made simple in structure. Therefore, the mode changing operation part can be arranged such that there is no gap between the electronic switch and an outer surface of the tool body. This configuration can improve the designability of the power tool. Further, this configuration can prevent dust from entering a gap between the mode changing operation part and the tool body and thus can prolong the life of the mode changing operation part.

In addition or in the alternative to the preceding embodiments, the second motor may be configured not to be driven while the first motor is driven.

According to this embodiment, wear and damage of the clutch member and components of the power tool, which may be caused if the second motor is driven while the first motor is driven, can be reduced.

In addition or in the alternative to the preceding embodiments, the power tool may further have an indicating part that is configured to indicate the action mode of the driving mechanism.

According to this embodiment, the power tool is provided that is capable of indicating the selected action mode to a user.

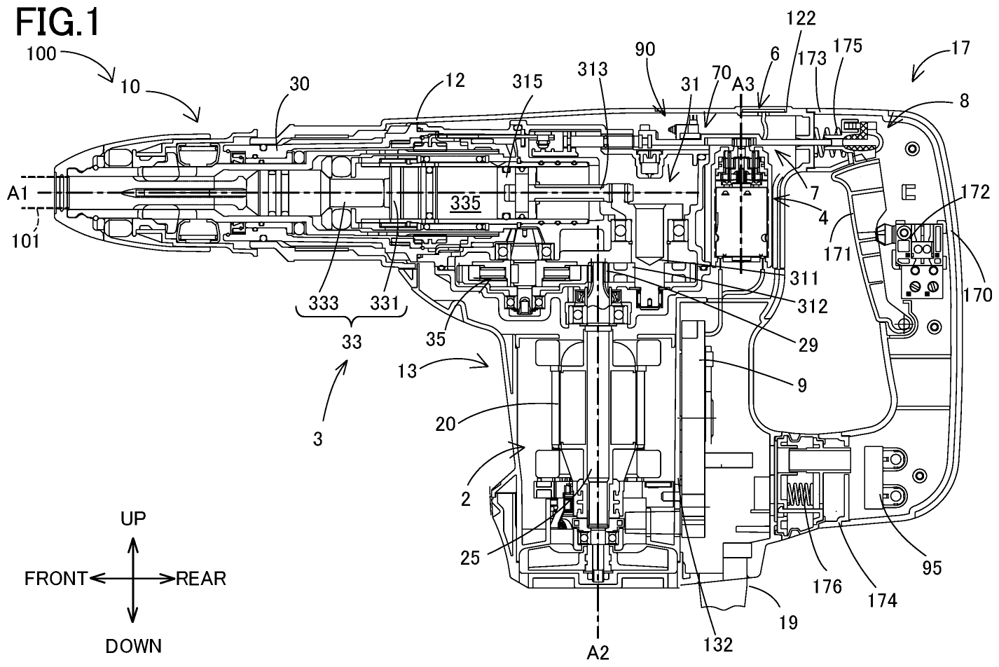

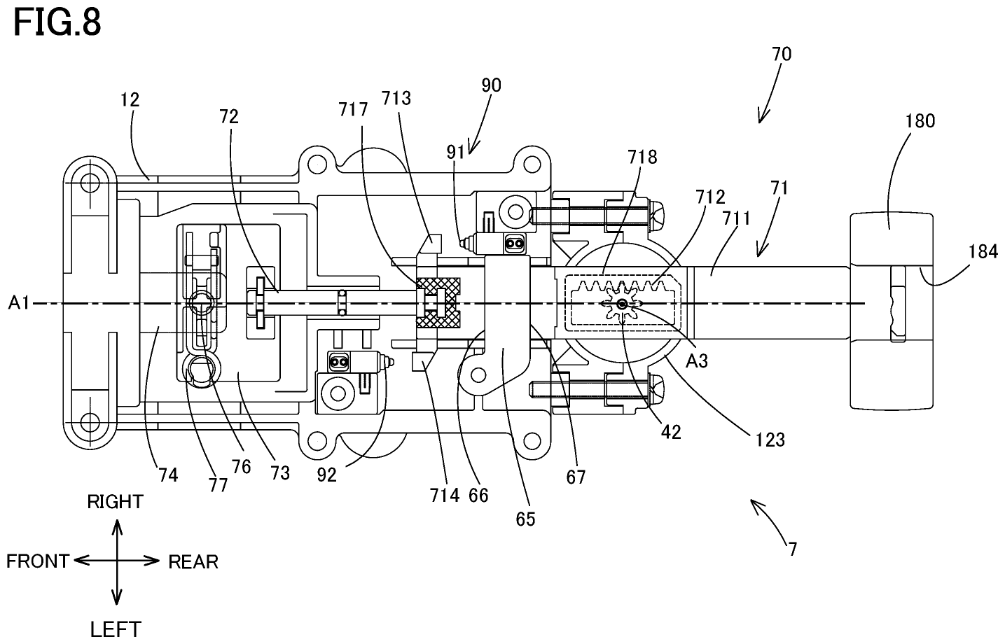

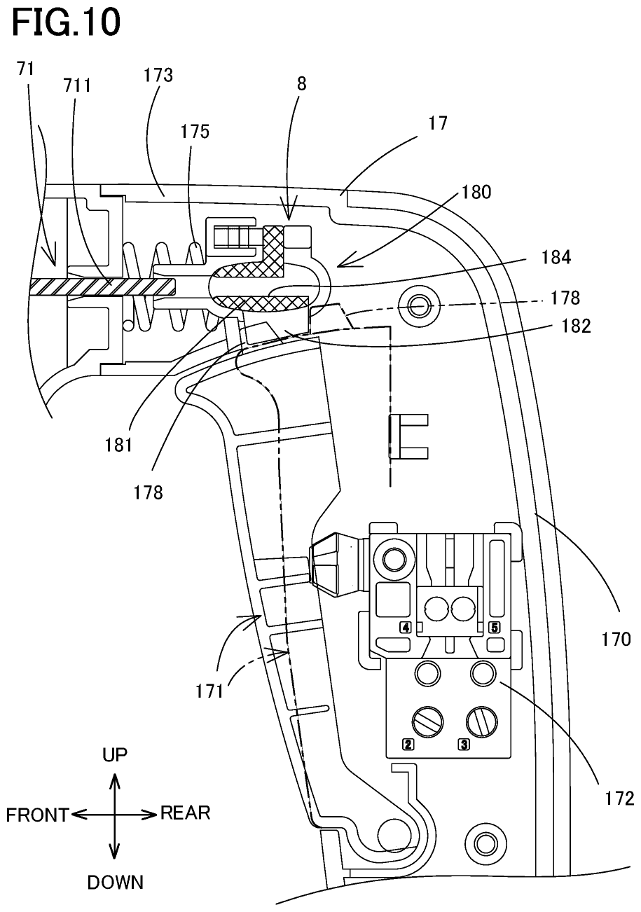

A power tool having a rotary hammer mechanism according to one embodiment of the present disclosure is now described with reference to FIGS. 1 to 11. In this embodiment, a rotary hammer 100 is described as a representative example of the power tool. The rotary hammer 100 is configured to rotationally drive a tool accessory 101 coupled to a tool holder 30 around a prescribed driving axis A1 (such motion is hereinafter referred to as rotating motion) and to linearly drive the tool accessory 101 in parallel to the driving axis A1 (such motion is hereinafter referred to as hammering motion).

First, the structure of the rotary hammer (also called a hammer drill) 100 as a whole is described in brief with reference to FIG. 1. The rotary hammer 100 includes a tool body 10 and a handle 17 connected to the tool body 10.

The tool body 10 includes a gear housing 12 extending along the driving axis A1 (the driving axis A1 direction), and a motor housing 13 connected to one end portion in a longitudinal direction of the gear housing 12 and extending in a direction crossing the driving axis A1. In this embodiment, the motor housing 13 extends in a direction substantially orthogonal to the driving axis A1. Thus, the tool body 10 is generally L-shaped as a whole.

A tool holder 30 is provided within the other end portion of the gear housing 12 in the longitudinal direction and configured to removably hold the tool accessory 101. A driving mechanism 3 is housed within the gear housing 12. The driving mechanism 3 is configured to operate in an action mode that is selected from a plurality of action modes including a mode of performing rotating motion and hammering motion (such mode is hereinafter referred to as rotary hammer mode (hammering with rotation mode)) and a mode of performing hammering only motion (such mode is hereinafter referred to as hammer mode), which will be described in detail below. A motor 2 is housed within the motor housing 13. The motor 2 is arranged such that a rotational axis A2 of a motor shaft 25 crosses (more specifically, extend orthogonally to) the driving axis A1. The gear housing 12 and the motor housing 13 are connected together so as to be immovable relative to each other.

The handle 17 includes a grip part 170 extending in a direction crossing (more specifically, orthogonal to) the driving axis A1 (driving axis A1 direction), and connection parts 173, 174 protruding from both end portions in a longitudinal direction of the grip part 170 in a direction crossing (more specifically, orthogonal to) the grip part 170. The handle 17 is generally C-shaped as a whole. The handle 17 is connected to an end portion of the tool body 10 on the side opposite from the tool holder 30 in the longitudinal direction of the tool body 10. More specifically, the connection part 173 is connected to the gear housing 12, and the connection part 174 is connected to the motor housing 13.

The structure of the rotary hammer 100 is now described in detail. In the following description, for convenience sake, the extending direction of the driving axis A1 of the rotary hammer 100 (the longitudinal direction of the gear housing 12) is defined as a front-rear direction of the rotary hammer 100. In the front-rear direction, the side of one end portion of the rotary hammer 100 in which the tool holder 30 is provided is defined as the front of the rotary hammer 100, and the opposite side is defined as the rear of the rotary hammer 100. The extending direction of the grip part 170 is defined as an up-down direction of the rotary hammer 100. In the up-down direction, the side of the rotary hammer 100 where the connection part 173 is connected to the gear housing 12 is defined as an upper side, and the opposite side is defined as a lower side. A direction orthogonal to the front-rear direction and the up-down direction is defined as a left-right direction.

First, the handle 17 is described. As described above, the handle 17 includes the grip part 170 extending in the up-down direction, the connection part 173 protruding forward from an upper end of the grip part 170, and the connection part 174 protruding forward from a lower end of the grip part 170. As shown in FIG. 1, elastic members 175 and 176 are respectively arranged between the connection part 173 and a rear upper end portion of the gear housing 12 and between the connection part 174 and a rear lower end portion of the motor housing 13. In this embodiment, compression coil springs are adopted as the elastic members 175, 176. The handle 17 is connected to be movable in the front-rear direction relative to the tool body 10 via the elastic members 175, 176. This structure reduces transmission of vibration (particularly, vibration caused in the front-rear direction by the hammering motion) from the tool body 10 to the handle 17.

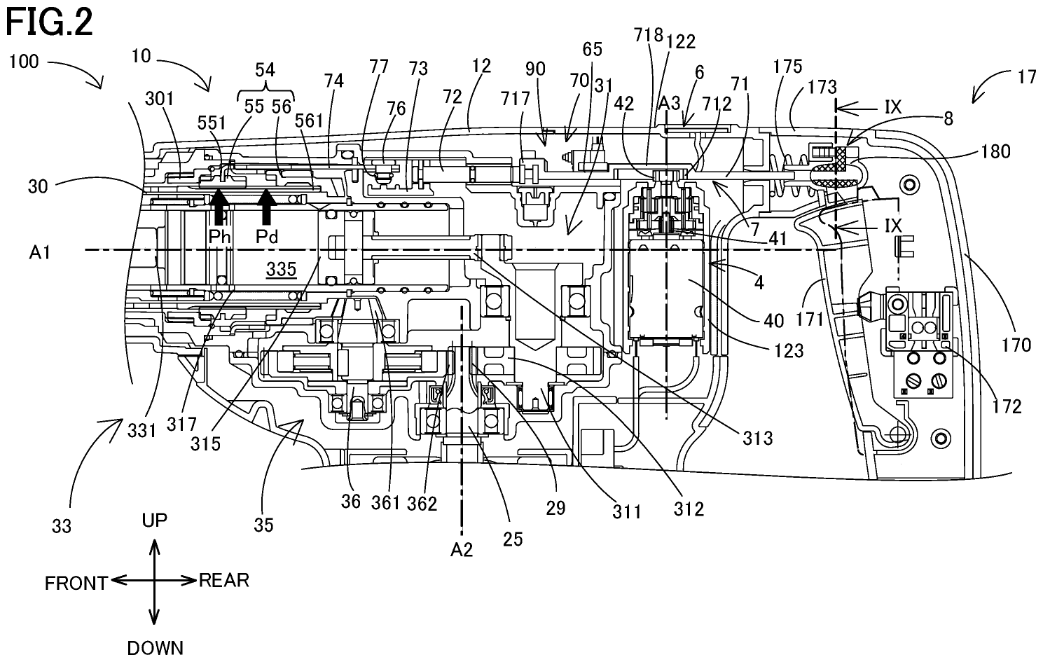

A switch lever 171 is provided in the grip part 170. The switch lever 171 is arranged extending upward from a substantially intermediate portion of the grip part 170 in the up-down direction on the front side of the grip part 170. The switch lever 171 is configured to be manually depressed by a user. In FIG. 2, OFF and ON positions of the switch lever 171 are shown by a solid line and a two-dot chain line, respectively. The switch lever 171 is normally held in the OFF position by being biased forward by a plunger of a main switch 172 disposed behind the switch lever 171, and when manually depressed by the user, the switch lever 171 is retracted rearward to the ON position within the grip part 170. When the switch lever 171 is moved to the ON position, the main switch 172 housed within the handle 17 is turned on, and the motor 2 is driven by control of a controller 9 described below.

A locking mechanism 8 is provided in the vicinity of the connection part 173 of the handle 17. The locking mechanism 8 is configured to lock the switch lever 171 in the ON position when the action mode is the hammer mode and not to lock the switch lever 171 in the ON position when the action mode is the rotary hammer mode. The locking mechanism 8 will be described below in further detail.

An acceleration sensor 95 is housed within the handle 17. In this embodiment, the acceleration sensor 95 is housed within a lower end portion of the grip part 170 and arranged relatively apart from the driving axis A1. The acceleration sensor 95 is configured to output signals indicating detected acceleration to the controller 9 described below. In this embodiment, the acceleration detected by the acceleration sensor 95 is used as an index that indicates the state of rotation of the tool body 10 around the driving axis A1.

The structures of elements disposed within the motor housing 13 are now described. The motor housing 13 mainly houses the first motor 2 and the controller 9.

As shown in FIG. 1, the first motor 2 has a motor body 20 including a stator and a rotor, and a motor shaft 25 extending from the rotor. The rotational axis A2 of the first motor 2 (the motor shaft 25) extends in the up-down direction. In this embodiment, an AC motor is adopted as the first motor 2 and is driven by power supply from an external power source via a power cord 19. The motor shaft 25 is rotatably supported at its upper and lower end portions by bearings. A driving gear 29 is formed on the upper end portions of the motor shaft 25 protruding into the gear housing 12.

The controller 9 is mounted to a rear wall 132 of the motor body 20. In this embodiment, the controller 9 is formed by a microcomputer including a CPU and memories and configured such that the CPU controls operation of the rotary hammer 100. The controller 9 is electrically connected to the main switch 172, the acceleration sensor 95, and a mode detecting part 90, a mode changing operation part 6 and an indicating part 61 that are described below, via electric wires (not shown). In this embodiment, when the main switch 172 is turned on, the controller 9 drives the first motor 2 according to the rotation speed set via an adjusting dial (not shown). Further, the controller 9 is configured to control driving of a second motor 4 (described below) in response to user's manual operation of the mode changing operation part 6 and a detection result of the mode detecting part 90, which will be described in detail below. The controller 9 is further configured to control driving of the first motor 2 and the second motor 4 based on the detection results of the acceleration sensor 95 and the mode detecting part 90.

The gear housing 12 is now described. The mode changing operation part 6 and the indicating part 61 are disposed on the gear housing 12.

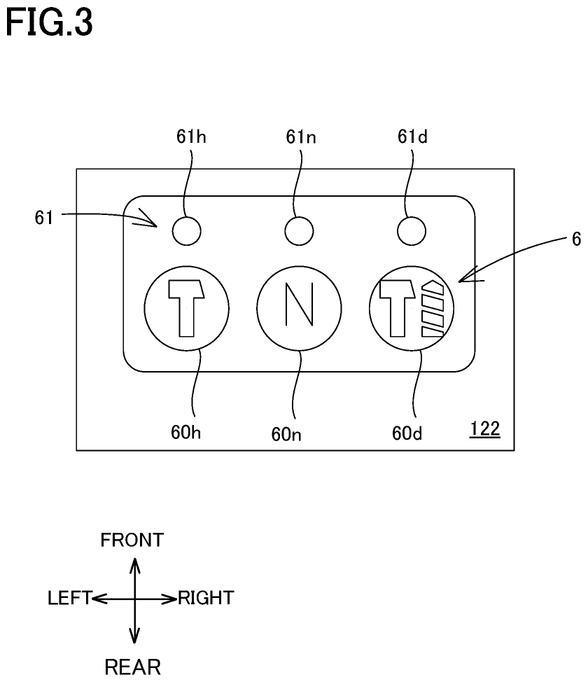

The mode changing operation part 6 is an electronic switch configured to be manually operated by a user to select the action mode. In this embodiment, as shown in FIGS. 1, 2, 5 and 7, the mode changing operation part 6 is in the vicinity of a connection between the gear housing 12 and the connection part 173 on an upper surface 122 of the gear housing 12. As shown in FIG. 3, the mode changing operation part 6 has three switches 60h, 60n, 60d for mode selection. The switches 60h, 60n, 60d correspond to the hammer mode, a neutral mode described below, and the rotary hammer mode, respectively. In this embodiment, each of the switches 60h, 60n, 60d is configured as an electronic switch to output an ON signal to the controller 9 when pressed. In this embodiment, the mode changing operation part 6 is arranged such that there is no gap between the mode changing operation part 6 and the upper surface 122 of the gear housing 12. This can prevent dust generated by machining operation from entering a gap between the mode changing operation part 6 and the upper surface 122.

The indicating part 61 is configured to indicate the selected action mode to a user. In this embodiment, as shown in FIG. 3, the indicating part 61 is disposed in a front portion of the mode changing operation part 6. The indicating part 61 has three LED (light emitting diode) lamps 61h, 61n, 61d, each of which is lighted by control of the controller 9. Specifically, the LED lamp 61h is lighted when the switch 60h is turned on (that is, the hammer mode is selected); the LED lamp 61n is lighted when the switch 60n is turned on (that is, the neutral mode is selected); and the LED lamp 61d is lighted when the switch 60d is turned on (that is, the rotary hammer mode is selected)

The structures of elements disposed within the gear housing 12 are now described.

The gear housing 12 mainly houses the tool holder 30, the driving mechanism 3, a transmitting mechanism 7, the second motor 4 and the mode detecting part 90. The gear housing 12 has a generally cylindrical front portion extending parallel to the driving axis A1. The tool holder 30 is housed in this cylindrical portion (also referred to as a barrel part). Although not shown, an auxiliary handle for assisting in holding the rotary hammer 100 can be attached to the barrel part.

The driving mechanism 3 includes a motion converting mechanism 31, a striking mechanism 33 and a rotation transmitting mechanism 35. Most of the motion converting mechanism 31 and the rotation transmitting mechanism 35 are housed in a rear portion of the gear housing 12.

The motion converting mechanism 31 is configured to convert rotation of the first motor 2 into linear motion and transmit it to the striking mechanism 33. In this embodiment, a known crank mechanism is adopted as the motion converting mechanism 31. As shown in FIG. 2, the motion converting mechanism 31 includes a crank shaft 311, a connecting rod 313 and a piston 315. The crank shaft 311 is arranged in parallel to the motor shaft 25 in a rear end portion of the gear housing 12. The crank shaft 311 has a driven gear 312 engaged with a driving gear 29. One end portion of the connecting rod 313 is connected to an eccentric pin, and the other end portion of the connecting rod 313 is connected to the piston 315 via a connection pin. The piston 315 is slidably disposed within a tubular cylinder 317. When the first motor 2 is driven, the piston 315 is reciprocated along (parallel to) the driving axis A1 (in the front-rear direction) within the cylinder 317.

The striking mechanism 33 includes a striker 331 and an impact bolt 333 (see FIG. 1). The striker 331 is disposed in front of the piston 315 so as to be slidable in the front-rear direction within the cylinder 317. An air chamber 335 is formed between the striker 331 and the piston 315 and serves to linearly move the striker 331 via air pressure fluctuations caused by reciprocating movement of the piston 315. The impact bolt 333 is configured to transmit kinetic energy of the striker 331 to the tool accessory 101. As shown in FIG. 1, the impact bolt 333 is arranged to be slidable in the front-rear direction within the tool holder 30 that is coaxially arranged with the cylinder 317.

When the first motor 2 is driven and the piston 315 is moved forward, air in the air chamber 335 is compressed and its internal pressure increases. The striker 331 is pushed forward at high speed by action of the air spring and collides with the impact bolt 333, thereby transmitting its kinetic energy to the tool accessory 101. As a result, the tool accessory 101 is linearly driven in parallel to the driving axis A1 and strikes a workpiece. On the other hand, when the piston 315 is moved rearward, air of the air chamber 335 expands so that the internal pressure decreases and the striker 331 is retracted rearward. The rotary hammer 100 produces (provides) hammering motion by causing the motion converting mechanism 31 and the striking mechanism 33 to repeat these operations.

The rotation transmitting mechanism 35 is configured to transmit torque of the motor shaft 25 to the tool holder 30. In this embodiment, as shown in FIG. 2, the rotation transmitting mechanism 35 includes the driving gear 29 formed on the motor shaft 25, an intermediate shaft 36 and a clutch mechanism 54. The rotation transmitting mechanism 35 is configured as a reduction gear mechanism, and the rotation speeds of the motor shaft 25, the intermediate shaft 36 and the tool holder 30 are reduced in this order.

The intermediate shaft 36 is arranged in front of and above the first motor 2 in parallel to the motor shaft 25. A driven gear 362 is provided on a lower portion of the intermediate shaft 36 and engaged with the driving gear 29. A small bevel gear 361 is provided on an upper end portion of the intermediate shaft 36.

The clutch mechanism 54 is on the tool holder 30. The clutch mechanism 54 is configured to transmit torque from the motor shaft 25 to the tool holder 30 or to interrupt the torque transmission. In this embodiment, the clutch mechanism 54 includes a gear sleeve 56 having a large bevel gear 561, and a driving sleeve 55. The gear sleeve 56 is supported around a rear end portion of the tool holder 30 so as to be rotatable around the driving axis A1. The large bevel gear 561 is engaged with the small bevel gear 361 provided on the upper end portion of the intermediate shaft 36.

The driving sleeve 55 has a tubular shape and is spline-connected to an outer periphery of the tool holder 30 in front of the gear sleeve 56. Thus, the driving sleeve 55 is engaged with the tool holder 30 so as to be restricted from moving in a circumferential direction relative to the tool holder 30 while being movable in the front-rear direction.

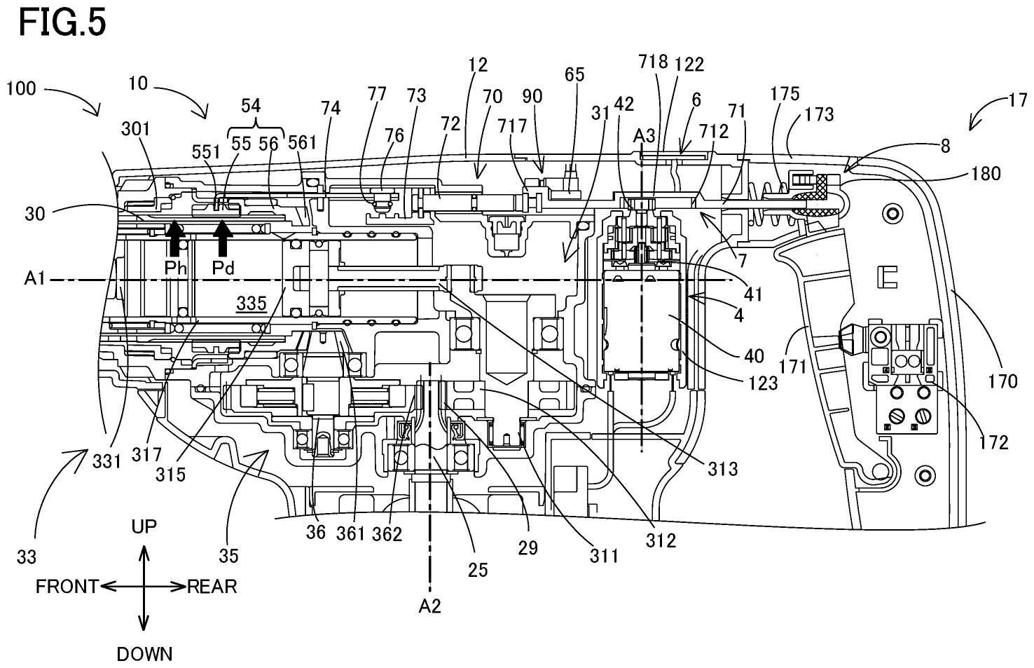

A rearmost position (such position is hereinafter referred to as a position Pd) and a foremost position (such position is hereinafter referred to as a position Ph) within a moving range of the driving sleeve 55 are shown in FIGS. 2, 5 and 7. The driving sleeve 55 is engaged with a front end portion of the gear sleeve 56 when moved to the position Pd (see FIG. 5). In this state, torque of the first motor 2 can be transmitted to the tool holder 30 via the rotation transmitting mechanism 35. When the first motor 2 is driven, the motion converting mechanism 31 is also driven as described above. Therefore, when the first motor 2 is driven while the driving sleeve 55 is in the position Pd, rotating motion and hammering motion are simultaneously performed in the rotary hammer 100. Thus, when the driving sleeve 55 is moved to the position Pd, the action mode of the rotary hammer 100 is changed (set) to the rotary hammer mode.

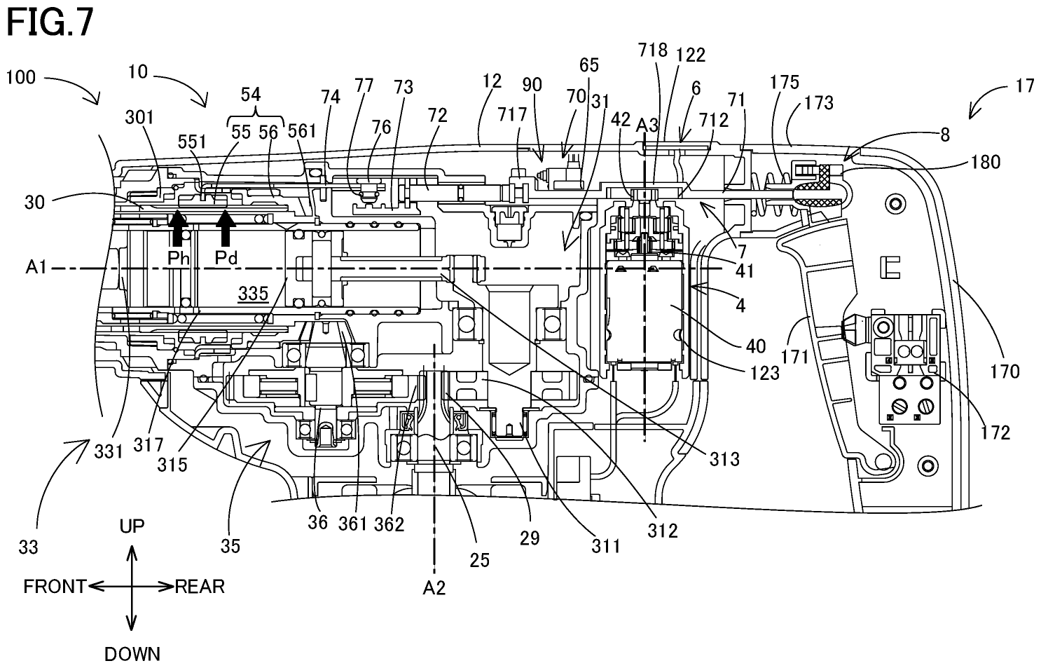

The driving sleeve 55 is disengaged from the gear sleeve 56 when moved forward from the position Pd (see FIG. 7). Thus, torque of the first motor 2 cannot be transmitted to the tool holder 30 via the rotation transmitting mechanism 35. When moved to the position Ph, as shown in FIG. 2, the driving sleeve 55 is engaged with a lock ring 301 fixed to the gear housing 12, so that the tool holder 30 cannot rotate around the driving axis A1. In this state, when the first motor 2 is driven, the motion converting mechanism 31 is driven, and hammering only motion is performed in the rotary hammer 100. Thus, when the driving sleeve 55 is moved to the position Ph, the action mode of the rotary hammer 100 is changed (set) to the hammer mode. In this manner, in the rotary hammer 100, the action mode is changed by the driving sleeve 55 being moved in parallel to the driving axis A1 (in the front-rear direction).

When the driving sleeve 55 is moved to between the position Ph and the position Pd as shown in FIG. 7, torque of the first motor 2 cannot be transmitted to the tool holder 30 as described above. Further, the driving sleeve 55 is not engaged with the lock ring 301, so that the tool holder 30 is not fixed to the gear housing 12. Therefore, in this state, a user can hold and turn the tool accessory 101 around the driving axis A1 with fingers together with the tool holder 30. Thus, the action mode of the rotary hammer 100 is changed (set) to a mode in which a user is allowed to position the tool accessory 101 on a workpiece. This action mode is also referred to as a “neutral mode”.

Returning to description of the structures of elements disposed within the gear housing 12, as shown in FIG. 2. In this embodiment, the second motor 4 is in a rear portion of the gear housing 12. The driving axis A1 extends through the second motor. The second motor 4 includes a motor body 40 having a stator and a rotor, and a motor shaft 41. The motor body 40 is housed within a motor case 123 that is supported by the gear housing 12. A rotational axis A3 of the motor shaft 41 extends in the up-down direction. The second motor 4 is controlled by the controller 9 to rotate in a first rotation direction or a second rotation direction opposite to the first rotation direction around the rotational axis A3. A planetary gear mechanism is provided directly above the second motor 4 and configured as a reduction gear. The speed of rotation of the motor shaft 41 is reduced by the planetary gear mechanism and this rotation is outputted from a pinion gear 42. The pinion gear 42 is fixed to an output shaft (a carrier of a second stage) of the planetary gear mechanism. In this embodiment, two stages (sets) of the planetary gear mechanisms are provided, but the number of the stages is not limited to two.

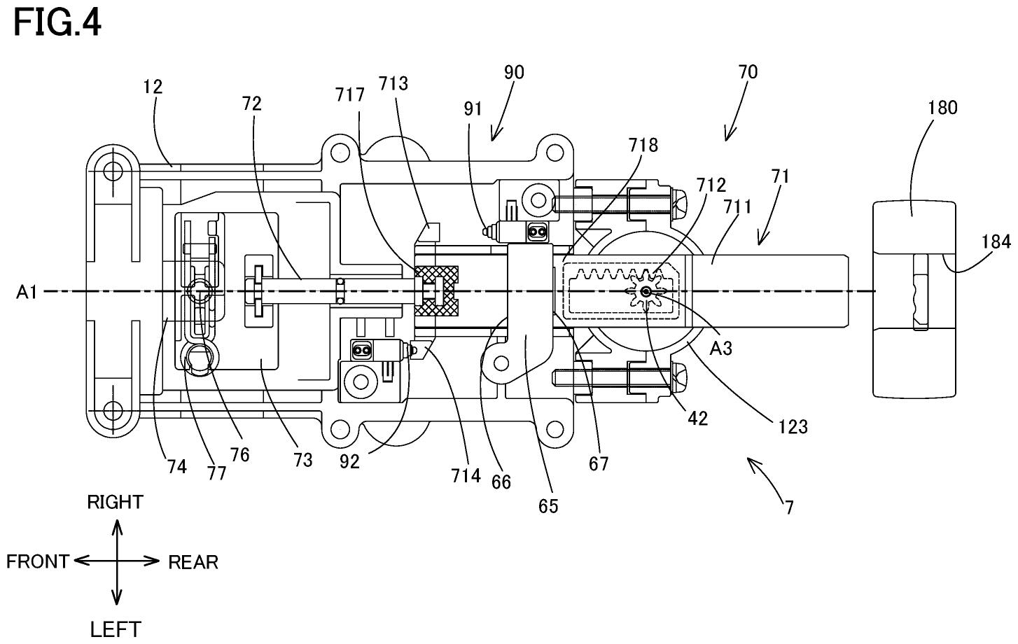

The transmitting mechanism 7 is configured to convert rotation of the second motor 4 into linear motion parallel to the driving axis A1 and transmit it to the driving sleeve 55. As shown in FIGS. 2 and 4, the transmitting mechanism 7 includes the pinion gear 42 and a connecting member 70. As described above, the pinion gear 42 is an output gear that is rotated by the second motor 4. The connecting member 70 includes a first member 71 having a rack gear 712, a second member 72, a third member 73, and an engagement arm 74 that is engaged with the driving sleeve 55. These members are connected in series in this order from rear to front and arranged within the gear housing 12 so as to be integrally movable in the front-rear direction. The connecting member 70 is moved in the front-rear direction via the rack gear 712 by rotation of the pinion gear 42. The connecting member 70 is configured to move the driving sleeve 55 to the position Ph by moving to a foremost position within a moving range and to move the driving sleeve 55 to the position Pd by moving to a rearmost position within the moving range. In this embodiment, the connecting member 70 moves rearward when the second motor 4 rotates in the first rotation direction, and it moves forward when the second motor 4 rotates in the second rotation direction.

The connecting member 70 is described in further detail. The first member 71 extends in the front-rear direction. The first member 71 has the rack gear 712 that is engaged with the pinion gear 42. When the pinion gear 42 rotates around the rotational axis A3, the rack gear 712 is moved in parallel to the driving axis A1 (in the front-rear direction) and thus the first member 71 is moved in the front-rear direction. In this manner, rotation of the second motor 4 is converted into linear motion parallel to the driving axis A1 by the pinion gear 42 and the rack gear 712.

As shown in FIGS. 2 and 4, the first member 71 has a plate-like part 711 extending in the front-rear direction orthogonal to the up-down direction, and first and second upper projections 717, 718 protruding upward from the plate-like part 711. The first projection 717 is at a front end of the first member 71, and the second upper projection 718 is apart rearward from the first projection 717. The rack gear 712 is on a lower side (lower surface) of the second upper projection 718. The first member 71 further has a right projection 713 protruding to the right from a front end portion of the plate-like part 711, and a left projection 714 protruding to the left from the front end portion of the plate-like part 711. The right and left projections 713, 714 are configured to abut on the mode detecting part 90 described below.

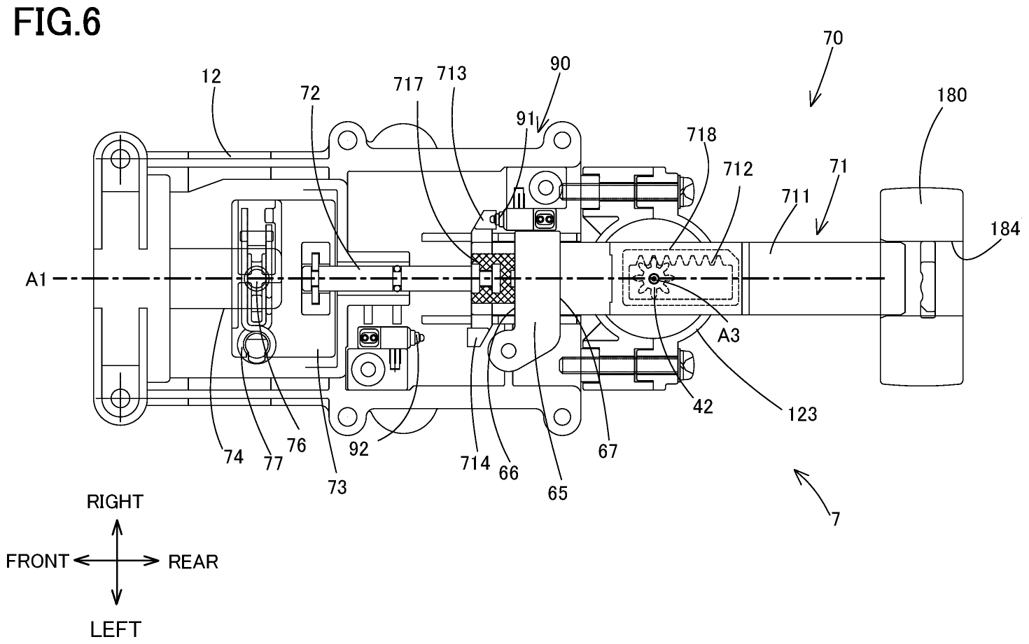

As shown in FIG. 4, a stopper 65 extending in the left-right direction is provided between the first and second upper projections 717, 718 in the front-rear direction and fixed to the gear housing 12. The stopper 65 has a front end surface 66 and a rear end surface 67 that cross the moving direction of the first member 71 (i.e. the front-rear direction). The stopper 65 is configured to position the driving sleeve 55 in the position Ph or in the position Pd by interfering with the first member 71. Specifically, as shown in FIG. 4, when the first member 71 moves forward, the stopper 65 positions the connecting member 70 in the foremost position within the moving range and positions the driving sleeve 55 in the position Ph by abutment of the rear end surface 67 on a front end of the second projection 718. Further, as shown in FIG. 6, when the first member 71 moves rearward, the stopper 65 positions the connecting member 70 in the rearmost position within the moving range and positions the driving sleeve 55 in the position Pd by abutment of the front end surface 66 on a rear end of the first projection 717.

Returning to description of the connecting member 70, the second member 72 is a rod-like member extending in the front-rear direction. A rear end portion of the second member 72 is inserted into the first projection 717 of the first member 71 and connected to the first member 71. In FIG. 4, a connection between the first member 71 and the second member 72 is shown by showing the inside of the first projection 717. The third member 73 is a rectangular member and a front end portion of the second member 72 is connected to a rear end portion of the third member 73. The engagement arm 74 is an elongate plate-like member extending in the front-rear direction. As shown in FIG. 2, a rear end portion of the engagement arm 74 is connected to a front end portion of the third member 73. A bifurcated front end portion of the engagement arm 74 is bent downward like a hook and engaged with an annular groove 551 formed in an outer periphery of the driving sleeve 55. In this embodiment, a through hole is formed in the rear end portion of the engagement arm 74, and a connection pin 76 is inserted through the through hole. Further, a torsion spring 77 is held on a left front end portion of the third member 73, and a lower end portion of the connection pin 76 is pinched between two arms of the torsion spring 77 by biasing force of the torsion spring 77. One of the two arms that is arranged on the rear side of the connection pin 76 is locked to the third member 73.

Next, the mode detecting part 90 is described. The mode detecting part 90 is configured to detect the action mode (a current actual action mode (currently selected operation mode), or specifically, the position of the driving sleeve 55) of the rotary hammer 100. In this embodiment, the mode detecting part 90 includes a first switch 91 and a second switch 92 that are arranged in an upper part of the gear housing 12. In this embodiment, the first and second switches 91, 92 are push type micro switches. The first and second switches 91, 92 are configured to output a signal (ON signal) to the controller 9 when pushed.

The first switch 91 is arranged behind the right projection 713 of the first member 71 to face the right projection 713, and fixed to the gear housing 12. The positional relation between the right projection 713 and the first switch 91 is adjusted such that a rear end surface of the right projection 713 abuts on the first switch 91 and pushes the first switch 91 rearward when the connecting member 70 is moved to the rearmost position (i.e. when the driving sleeve 55 is moved to the position Pd). The second switch 92 is arranged in front of the left projection 714 of the first member 71 to face the left projection 714, and fixed to the gear housing 12. The positional relation between the left projection 714 and the second switch 92 is adjusted such that a front end surface of the left projection 714 abuts on the second switch 92 and pushes the second switch 92 forward when the connecting member 70 is moved to the foremost position (i.e. when the driving sleeve 55 is moved to the position Ph).

With such a structure, the controller 9 can determine (detect) the action mode of the rotary hammer 100 from detection results of the first and second switches 91, 92 (i.e. the position of the driving sleeve 55). Specifically, the action mode of the rotary hammer 100 is determined as the rotary hammer mode when an ON signal is outputted from the first switch 91 to the controller 9, and determined as the hammer mode when an ON signal is outputted from the second switch 92 to the controller 9. When an ON signal is not outputted from the first and second switches 91, 92, the action mode is determined as the neutral mode.

In this embodiment, the controller 9 is configured to control driving of the second motor 4 based on the detection results of the mode changing operation part 6 and the mode detecting part 90. Specifically, when receiving an ON signal of the switch 60h corresponding to the hammer mode while not receiving an ON signal of the second switch 92 (while the second switch 92 is OFF), the controller 9 rotates the second motor 4 in the second rotation direction so as to move the connecting member 70 to the foremost position. When the rack gear 712 is moved forward by rotation of the pinion gear 42, the first member 71 is moved forward and moves the driving sleeve 55 to the position Ph (see FIGS. 1, 2 and 4). As a result, the action mode of the rotary hammer 100 is changed to the hammer mode. At this time, the second switch 92 is pushed by the connecting member 70 moved to the foremost position, and outputs an ON signal to the controller 9. When receiving the ON signal of the second switch 92, the controller 9 stops the second motor 4.

Further, when receiving an ON signal of the switch 60d corresponding to the rotary hammer mode while the first switch 91 is OFF, the controller 9 rotates the second motor 4 in the first rotation direction so as to move the connecting member 70 to the rearmost position. When the rack gear 712 is moved rearward by rotation of the pinion gear 42, the connecting member 70 is moved rearward and moves the driving sleeve 55 to the position Pd (see FIGS. 5 and 6). As a result, the action mode of the rotary hammer 100 is changed to the rotary hammer mode. At this time, the first switch 91 is pushed by the connecting member 70 moved to the rearmost position, and outputs an ON signal to the controller 9. When receiving the ON signal of the first switch 91, the controller 9 stops the second motor 4.

Furthermore, when receiving an ON signal of the switch 60n corresponding to the neutral mode while the first switch 91 or the second switch 92 is ON, the controller 9 rotates the second motor 4 so as to move the driving sleeve 55 to between the position Ph and the position Pd based on a currently obtained detection result of the mode detecting part 90. Specifically, when receiving an ON signal from the first switch 91 (when the connecting member 70 is located in the rearmost position), the controller 9 rotates the second motor 4 in the second rotation direction so as to move the connecting member 70 forward, and when the first switch 91 is turned off, the controller 9 stops the second motor 4. When receiving an ON signal from the second switch 92 (when the connecting member 70 is located in the foremost position), the controller 9 rotates the second motor 4 in the first rotation direction so as to move the connecting member 70 rearward, and when the second switch 92 is turned off, the controller 9 stops the second motor 4. In this manner, the driving sleeve 55 is placed in an intermediate position between the position Ph and the position Pd, and the action mode of the rotary hammer 100 is changed to the neutral mode.

In this embodiment, the controller 9 is configured not to drive the second motor 4 while driving the first motor 2 even if the mode changing operation part 6 is operated. In this embodiment, the controller 9 is configured to control driving of the second motor 4 based on the detection results of the mode changing operation part 6 and the mode detecting part 90 when stopping the first motor 2.

As described above, the connecting member 70 is positioned in the foremost position by abutment of the second projection 718 on the rear end surface 67 of the stopper 65 when the connecting member 70 (the first member 71) moves forward (see FIG. 4). Further, the connecting member 70 is positioned in the rearmost position by abutment of the first projection 717 on the front end surface 66 of the stopper 65 when the connecting member 70 (the first member 71) moves rearward (see FIG. 6). Thus, the connecting member 70 is prevented from moving further forward or rearward even if the second motor 4 is rotated by inertia after the controller 9 stops the second motor 4 based on the detection result of the mode detection part 90.

Control of operation of the rotary hammer 100 by the controller 9 based on the detection results of the mode detecting part 90 and the acceleration sensor 95 is now described. In the rotary hammer mode which involves rotating motion, if the tool holder 30 cannot rotate (is locked or blocked) due to jamming of the tool accessory 101 on the workpiece, excessive reaction torque may act on the tool body 10 and cause excessive rotation (kickback) of the tool body 10 around the driving axis A1.

In this embodiment, when the first motor 2 is driven, the controller 9 obtains detection results of the acceleration sensor 95 and successively determines whether the detection results exceed a predetermined threshold. The threshold is a threshold of acceleration obtained when the tool body 10 excessively rotates around the driving axis A1, and is stored in advance in a memory of the controller 9. The threshold can be obtained by experiment or simulation.

Further, the controller 9 determines whether the action mode is the rotary hammer mode based on the detection result of the mode detecting part 90. In this embodiment, when receiving an ON signal from the first switch 91, the controller 9 determines that the action mode is the rotary hammer mode.

When the acceleration exceeds the threshold and the action mode is the rotary hammer mode, the controller 9 rotates the second motor 4 in the second rotation direction, thus moving the driving sleeve 55 forward via the connecting member 70 and disengaging the driving sleeve 55 from the gear sleeve 56. Therefore, transmission of torque to the tool holder 30 is interrupted and rotation of the tool body 10 (tool holder 30) is stopped. Further, when receiving an ON signal of the second switch 92 (when the action mode is changed to the hammer mode) after rotating the second motor 4 in the second rotation direction, the controller 9 stops driving of the second motor 4.

In this embodiment, when the acceleration exceeds the threshold and the action mode is the rotary hammer mode, the controller 9 further stops driving of the first motor 2. Thus, the operation of the rotary hammer 100 is completely stopped.

In this embodiment, when not receiving an ON signal from the first switch 91 (i.e. when the detection result of the mode detecting part 90 does not indicate the rotary hammer mode) even if the detection results of the acceleration sensor 95 exceed the threshold, the controller 9 does not drive the second motor 4 and continues driving of the first motor 2. This allows the user to continue operation in the hammer mode even if the detection results of the acceleration sensor 95 temporarily exceed the threshold, for example, due to impact of contact of the rotary hammer 100 with a wall or the like around the workpiece during operation in the hammer mode.

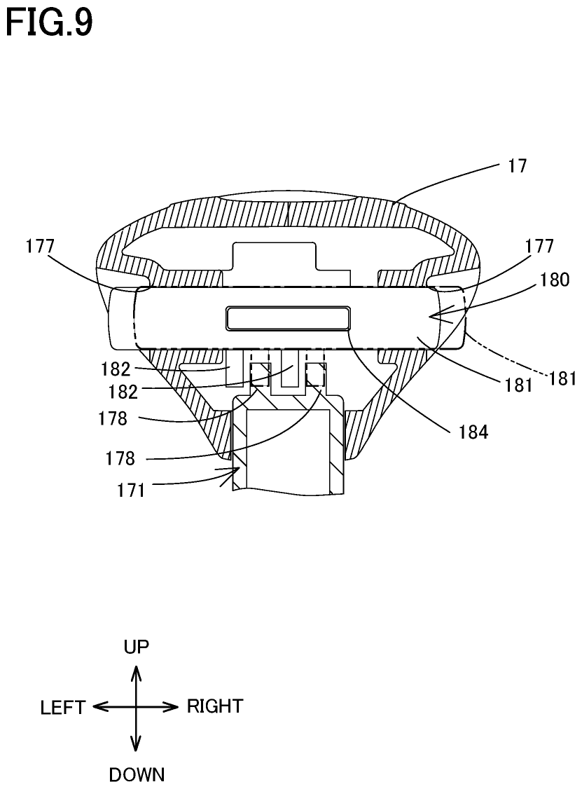

The locking mechanism 8 is now described with reference to FIGS. 9 to 11. In this embodiment, the locking mechanism 8 includes a lock lever 180 and the first member 71.

The lock lever 180 is provided directly above the switch lever 171 in the upper end portion (in the vicinity of the connection part 173) of the handle 17, and supported to be movable in the left-right direction relative to the handle 17. In this embodiment, the lock lever 180 has a rod-like body 181 extending in the left-right direction, and two locking pieces 182 protruding downward from a lower end of the body 181. As shown in FIG. 9, opposite end portions of the body 181 in the left-right direction are exposed through openings 177 formed in left and right walls of the connection part 173. A user can manually operate (manipulate) the lock lever 180 by pushing the body 181 to the left or right relative to the handle 17.

The switch lever 171 of this embodiment has two locking projections 178 protruding upward. As shown in solid lines in FIG. 9, the two locking pieces 182 of the lock lever 180 are spaced apart from each other in the left-right direction such that one of the locking projections 178 of the switch lever 171 can pass between the locking pieces 182. As shown in two-dot chain lines in FIG. 9, the distance between the two locking pieces 182 of the lock lever 180 is equal to the distance between the two locking projections 178 of the switch lever 171.

The lock lever 180 can be moved to a lock position, in which the lock lever 180 can lock the switch lever 171 in the ON position, and to a non-lock position, in which the lock lever 180 cannot lock the switch lever 171 in the ON position. More specifically, the lock position is a position of the lock lever 180 where the locking pieces 182 of the lock lever 180 are respectively on moving paths of the locking projections 178 of the switch lever 171 as shown in two-dot chain lines in FIG. 9. In the lock position, rear ends of the locking pieces 182 of the lock lever 180 can abut on front ends of the locking projections 178 of the switch lever 171 in the ON position, so that the switch lever 171 can be held in the ON position. The non-lock position is a position of the lock lever 180 where the locking pieces 182 of the lock lever 180 are respectively out of the moving paths of the locking projections 178 of the switch lever 171 as shown in solid lines in FIG. 9. In the non-lock position, the locking pieces 182 do not interfere with movement of the locking projections 178 in the front-rear direction, so that the switch lever 171 can be moved between the ON position and the OFF position. The lock lever 180 is normally placed in the non-lock position (shown in solid lines in FIG. 9) by a user so as to allow operation of the switch lever 171, and is moved to the lock position by the user only when locking the switch lever 171 in the ON position. Although not shown, in this embodiment, the lock lever 180 is held in the non-lock position or in the lock position by biasing force of a biasing member.

The lock lever 180 has a lock hole 184 formed in a substantially central portion of the body 181 in the left-right direction and extending through the body 181 in the front-rear direction. The lock hole 184 has a height in the up-down direction and a width in the left-right direction to allow insertion of the plate-like member 711 of the first member 71. The first member 71 forms part of the connecting member 70 as described above and moves in the front-rear direction in response to the user's operation of the mode changing operation part 6.

The positional relation between the connecting member 70 and the lock hole 184 is shown in FIGS. 4, 6 and 8. The plate-like member 711 of the first member 71 extends in the front-rear direction. The plat-like member 711 is configured to be engaged with the lock hole 184 when moved to the rearmost position within the moving range (i.e. when the rotary hammer mode is selected), and to be disengaged from the lock hole 184 when moved forward from the rearmost position (i.e. when the neutral mode or the hammer mode is selected).

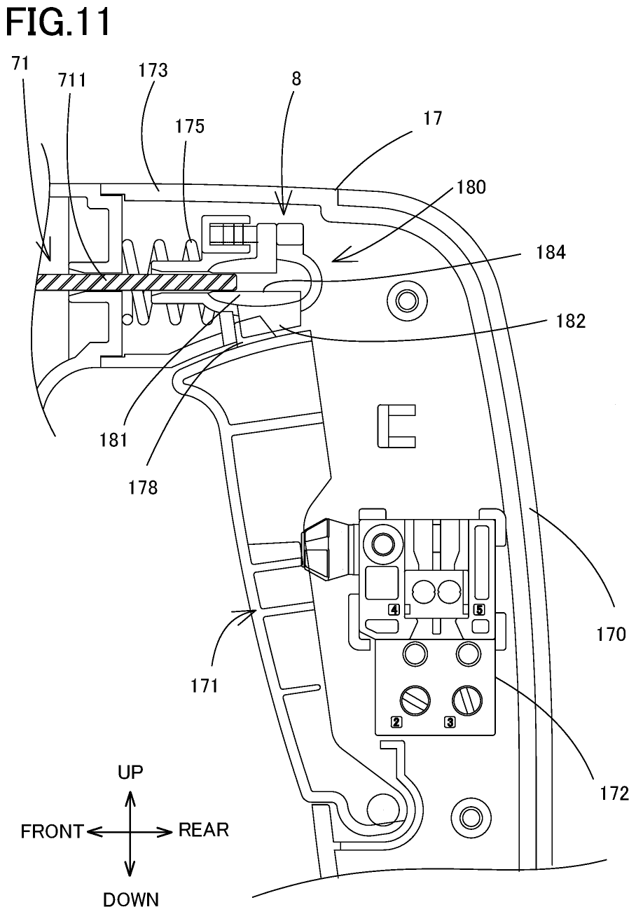

With the above-described structure, when the switch 60d of the mode changing operation part 6 is turned on (i.e. when the rotary hammer mode is selected), the connecting member 70 is moved to the rearmost position within the moving range and the plate-like member 711 is engaged with the lock hole 184 (see FIGS. 6 and 11). Thus, the lock lever 180 is restricted from moving in the left-right direction by the first member 71 and locked in the non-lock position. When the switch 60h of the mode changing operation part 6 is turned on (i.e. when the hammer mode is selected), the connecting member 70 is moved to the foremost position within the moving range and the plate-like member 711 is disengaged from the lock hole 184 (see FIGS. 4 and 9). Thus, the lock lever 180 can be moved in the left-right direction. In this state, when the lock lever 180 is moved to the lock position by a user, the switch lever 171 is held in the ON position. Thus, in the hammer mode, the user can keep the ON state of the switch lever 171 by pushing the lock lever 180 to the lock position, without keeping manually depressing the switch lever 171.

The above-described rotary hammer 100 according to this embodiment has the following effects.

In the rotary hammer 100 according to this embodiment, the action mode can be changed by the transmitting mechanism 7 converting rotation of the second motor 4 into linear motion and transmitting it to the driving sleeve 55 and moving the driving sleeve 55 in parallel to the driving axis A1. Further, the rotary hammer 100 is configured to, when the tool body 10 excessively rotates around the driving axis A1, drive the second motor 4 to move the driving sleeve 55 via the transmitting mechanism 7 to thereby interrupt transmission of torque to the tool holder 30. Thus, when the tool body 10 excessively rotates around the driving axis A1, the rotation of the tool body 10 is stopped. Therefore, according to this embodiment, the rotary hammer 100 is provided that in which change of the action mode and interruption of torque transmission the same second motor 4 is used for so that the safety can be enhanced.

The controller 9 is configured to, when determining that the tool body 10 is excessively rotated around the driving axis A1 based on detection results of the acceleration sensor 95, stop driving of the first motor 2 that is a drive source of the tool accessory 101, as well as to drive the second motor 4 to interrupt torque transmission. Thus, the safety of the rotary hammer 100 can be further enhanced.

The second motor 4 is on the driving axis A1 and the rotational axis A3 of the second motor 4 extends in a direction crossing the driving axis A1. Thus, the second motor 4 can be arranged close to the driving sleeve 55, compared with a structure in which the rotational axis A3 of the second motor 4 extends in parallel to the driving axis A1 and the second motor 4 is not arranged on the driving axis A1. Therefore, the transmitting mechanism 7 can be formed compact, so that the rotary hammer 100 can be reduced in size.

The transmitting mechanism 7 has the pinion gear 42 as an output gear of the second motor 4, and the first member 71 having the rack gear 712 that is engaged with the pinion gear 42. Thus, the driving sleeve 55 is moved in the front-rear direction by converting rotation of the second motor 4 into linear motion parallel to the driving axis A1 via the pinion gear 42 and the rack gear 712. Further, the conversion from the rotation to the liner motion can be easily achieved via the pinion gear 42 and the rack gear 712.

The rotary hammer 100 has the mode detecting part 90 that is configured to detect the action mode. The mode detecting part 90 includes the first switch 91 and the second switch 92. The first switch 91 is configured to abut on the first member 71 when the driving sleeve 55 is moved to the position Pd, and the second switch 92 is configured to abut on the first member 71 when the driving sleeve 55 is moved to the position Ph. Thus, in the rotary hammer 100 of this embodiment, it can be determined from the detection result of the first switch 91 that the action mode is the rotary hammer mode, and determined from the detection result of the second switch 92 that the action mode is the hammer mode.

In this embodiment, the controller 9 does not drive the second motor 4 nor stop the first motor 1 when the action mode is not the rotary hammer mode even if the tool body 10 excessively rotates around the driving axis A1. Thus, the user can continue operation in the hammer mode even if the detection results of the acceleration sensor 95 temporarily exceed the threshold, for example, due to impact of contact of the rotary hammer 100 with a wall or the like around the workpiece during operation in the hammer mode. Therefore, the possibility of the action mode being changed, or the first motor 2 being stopped, without an intention of a user during the hammer mode is reduced. Thus, according to this embodiment, the rotary hammer 100 can be provided with improved safety and maneuverability.

In this embodiment, the controller 9 is configured to drive the second motor 4 to move the connecting member 70 and thereby change the action mode, and to stop the second motor 4 when receiving an ON signal from the first switch 91 or the second switch 92. Thus, the mode detecting part 90 can be utilized to control the timing of stopping the second motor 4.

Further, the rotary hammer 100 has the stopper 65 fixed to the gear housing 12. The stopper 65 is configured to position the driving sleeve 55 in the position Pd by interference of the front end surface 66 with the first member 71, and to position the driving sleeve 55 in the position Ph by interference of the rear end surface 67 with the first member 71. Thus, the accuracy of positioning the driving sleeve 55 can be enhanced. Further, the stopper 65 can restrict movement of the first member 71 (the connecting member 70) even if the second motor 4 is rotated by inertia after the controller 9 stops the second motor 4 based on the detection result of the mode detection part 90. Therefore, compared with the rotary hammer 100 not having the stopper 65, provision of the stopper 65 can reduce application of excessive load of the connecting member 70 on the first and second switches 91, 92 and thus can prolong the lives of the first and second switches 91, 92.

The rotary hammer 100 of this embodiment has the locking mechanism 8. The locking mechanism 8 is configured such that, in the hammer mode in which the tool accessory 101 produces (provides) hammering only motion, the first member 71 is not engaged with the lock lever 180 and thus allows the lock lever 180 to move to the lock position. Therefore, the user need not keep manually depressing the switching lever 171 during operation of continuously performing hammering only motion for a relatively long time. Thus, the burden on the user during the operation can be reduced. Further, the locking mechanism 8 is configured such that, in the rotary hammer mode in which the tool accessory 101 produces (provides) rotating motion, the first member 71 is engaged with the lock lever 180 and holds the lock lever 180 in the non-lock position. Thus, the user can stop driving of the first motor 2 simply by releasing the switch lever 171, for example, even if the tool accessory 101 is jammed on the workpiece. Therefore, the rotary hammer 100 can be provided with high safety.

In the rotary hammer 100, the acceleration sensor 95 is housed within the handle 17, and the tool holder 10 and the handle 17 are connected via the elastic members 175, 176. This structure can reduce transmission of vibration from the tool body 10 to the acceleration sensor 95 and thus prolongs the life of the acceleration sensor 95.

Further, in this embodiment, the acceleration sensor 95 is housed in a lower part of the handle 17. Therefore, the accuracy of detecting rotation of the tool body 10 around the driving axis A1 is enhanced, compared with a structure in which the acceleration sensor 95 is housed in a position close to the driving axis A1, such as in an upper portion of the handle 17.

The rotary hammer 100 is configured to drive the second motor 4 to change the action mode via the transmitting mechanism 7. Therefore, an operation part for changing the action mode (the mode changing operation part 6) can be configured as an electronic switch for outputting an ON signal. Further, the mode changing operation part 6 can be on an outer surface of the tool body 10 without a gap therebetween. This configuration can improve the designability of the rotary hammer 100. Further, this configuration can prevent dust from entering a gap between the mode changing operation part 6 and the tool body 10 and thus prolongs the life of the mode changing operation part 6.

In this embodiment, the second motor 4 is configured not to be driven while the first motor 2 is driven even if the mode changing operation part 6 is operated. Thus, the second motor 4 is not driven, for example, even if the mode changing operation part 6 is operated accidentally by contact with an object around the rotary hammer 100 during machining operation (while the first motor 2 is driven). This configuration can reduce wear and damage of the clutch mechanism 54 and components of the rotary hammer 100 which may be caused if the second motor 4 is driven while the first motor 2 is driven.

The rotary hammer 100 further has the indicating part 61 configured to be lighted corresponding to the selected action mode. Thus, the user can recognize the selected action mode even when it is difficult or impossible to recognize the switch operation state just by visually checking the mode changing operation part 6.

### Correspondences

Correspondences between the features of the above-described embodiment and the features of the present disclosure are as follows. The features of the above-described embodiment are merely exemplary and do not limit the features of the present disclosure.

The rotary hammer 100 is an example of the “power tool having a rotary hammer mechanism”.

The tool body 10 is an example of the “tool body”.

The first motor 2 is an example of the “first motor”.

The tool accessory 101 is an example of the “tool accessory”.

The driving axis A1 is an example of the “driving axis”.

The driving mechanism 3 is an example of the “driving mechanism”.

The rotary hammer mode is an example of the “first mode”.

The hammer mode is an example of the “second mode”.

The tool holder 30 is an example of the “tool holder”.

The second motor 4 is an example of the “second motor”.

The transmitting mechanism 7, the pinion gear 42 and the connecting member 70 are examples of the “transmitting mechanism”.

The driving sleeve 55 is an example of the “clutch member”.

The positions Pd and Ph are examples of the “transmitting position” and the “interrupting position”, respectively.

The acceleration sensor 95 is an example of the “rotation detecting part”.

The controller 9 and the CPU are examples of the “controlling part”.

The mode detecting part 90 is an example of the “mode detecting part”.

The first switch 91 and the second switch 92 are examples of the “first detecting part” and the “second detecting part”, respectively.

The first member 71 is an example of the “first member”.

The stopper 65 is an example of the “stopper”.

The “rearward” and “forward” directions are examples of the “first direction” and the “second direction”, respectively.

The front end surface 66 and the rear end surface 67 are examples of the “first surface” and the “second surface”, respectively.

The rotational axis A3 is an example of the “rotational axis of the second motor”. The motor shaft 41 is an example of the “motor shaft”.

The pinion gear 42 and the rack gear 712 are examples of the “pinion gear” and the “rack gear”, respectively.

The switch lever 171 is an example of the “main operation member”.

The lock lever 180 is an example of the “locking member”.

The first member 71 is an example of the “lock controlling member”.

The grip part 170 and the handle 17 are examples of the “grip part” and the “handle”, respectively.

The elastic members 175, 176 are examples of the “elastic member”.

The mode changing operation part 6 is an example of the “mode changing operation part”.

The indicating part 61 is an example of the “indicating part”.

### Other Embodiments

In the above-described embodiment, when the detection results of the acceleration sensor 95 exceed the threshold and the action mode is the rotary hammer mode, the controller 9 rotates the second motor 4 in the second rotation direction to interrupt torque transmission and stops driving of the first motor 2. Alternatively, the controller 9 may be configured to, when the acceleration exceeds the threshold and the action mode is the rotary hammer mode, rotate the second motor 4 in the second rotation direction and continue driving of the first motor 2 (that is, continue hammering only motion). In this case, torque transmission to the tool holder 30 is also interrupted, so that the state of excessive rotation of the tool body 10 can be eliminated.

In the above-described embodiment, when the detection result of the acceleration sensor 95 exceed the threshold and the action mode is the rotary hammer mode, the controller 9 rotates the second motor 4 in the second rotation direction to interrupt torque transmission, and when subsequently receiving an ON signal of the second switch 92 (when the action mode is changed to the hammer mode), the controller 9 stops driving of the second motor 4. Alternatively, the controller 9 may be configured to stop driving of the second motor 4 when the first switch 91 is turned off even if not receiving an ON signal of the second switch 92 (when the action mode is changed to the neutral mode). In this case, torque transmission to the tool holder 30 is also interrupted, so that the state of excessive rotation of the tool body 10 can be eliminated.

The mode changing operation part 6 is not limited to a press type electronic switch. For example, the mode changing operation part 6 may be a touch panel, or it may be a lever-type switch or other similar switches having an operation part configured to be moved by a user to select the action mode.

The rotary hammer 100 may have a display device such as a liquid crystal panel or a speaker, in place of the LED lamps 61h, 61n, 61d, and may be configured to indicate the action mode to the user by displaying characters on the display device or outputting sound from the speaker.

In the above-described embodiment, the rotary hammer 100 may be configured to be operated by power supplied not from an external AC power source but from a rechargeable battery. In this case, in place of the power cord 19, a battery mounting part, which is configured to removably receive the battery, may be provided, for example, in a lower end portion of the handle 17.

The mode detecting part 90 is not limited to a push type micro switch, but may include a detector(s) of a different type that is configured to detect the position (movement) of the driving sleeve 55. Examples of the detector may include a contact type detector (e.g., a switch of other type), a non-contact type detector (e.g., a magnetic sensor and an optical sensor).

The rotary hammer 100 may have any other detecting device capable of detecting the state of rotation of the tool body 10 around the driving axis A1, in place of the acceleration sensor 95. Examples of the detecting device may include a speed sensor, an angular speed sensor and an angular acceleration sensor.

In the above-described embodiment, the rotary hammer 100 is capable of operating in an operation mode, which is selected from the plurality of action modes including the rotary hammer mode and the hammer mode. The above-described embodiment may however be applied to a power tool having a rotary hammer mechanism that is configured to selectively operate in any of the rotary hammer mode, the hammer mode and a rotation mode. In this case, in the rotation mode, driving of the first motor 2 and the second motor 4 may be controlled in the same manner as in the rotary hammer mode.

The structure of the transmitting mechanism 7 is not limited to the structure of the above-described embodiment, as long as the transmitting mechanism 7 moves the driving sleeve 55 along the driving axis A1 in response to rotation of the second motor 4. In the case of the transmitting mechanism 7 having the connecting member 70, it is sufficient for the connecting member 70 to move in parallel to the driving axis A1 along with movement of the rack gear 712, and the number and structures of parts (components, elements) of the connecting member 70 and connection between the parts are not limited to those of the above-described embodiment.

In the above-described embodiment, the drive control of the first motor 2 is executed by the CPU, but other kinds of control circuits, including programmable logic devices such as an ASIC (application specific integrated circuit) and an FPGA (field programmable gate array), may be adopted in place of the CPU. The drive control of the first motor 2 and the second motor 4 may be executed by a plurality of control circuits in a distributed manner.

In the above-described embodiment, the driving sleeve 55 (the clutch mechanism 54) is on the tool holder 30 and configured to move along the driving axis A1 to the position Pd for transmitting torque and to the position Ph for interrupting the torque transmission. Alternatively, a clutch mechanism for transmitting torque to the tool holder 30 and interrupting the torque transmission may be provided at a position other than on the tool holder 30. Further, the transmitting mechanism 7 may just be configured to convert rotation of the second motor 4 into linear motion and transmit it to a clutch member (the driving sleeve 55), and may be configured to be movable in a direction different from a direction along the driving axis A1.

In view of the nature of the present disclosure and the above-described embodiment, the following aspects are provided. At least one of the aspects can be employed in combination with at least one of the above-described embodiment and modifications and the claimed invention.

(Aspect 1) The power tool having a rotary hammer mechanism may have a controlling part that is configured to control the second motor. The controlling part may be configured to drive the second motor to move the clutch member from the transmitting position when determining that the tool body is excessively rotated around the driving axis.
(Aspect 2) The power tool having a rotary hammer mechanism may have:

a mode changing operation part that is configured to be manually operated by a user to select the action mode of the driving mechanism; and

a controlling part that is configured to control driving of the second motor in response to the operation of the mode changing operation part.

### DESCRIPTION OF THE REFERENCE NUMERALS

2: first motor, 3: driving mechanism, 4: second motor, 6: mode changing operation part, 7: transmitting mechanism, 8: locking mechanism, 9: controller, 10: tool body, 12: gear housing, 13: motor housing, 17: handle, 19: power cord, 20: motor body, 25: motor shaft, 29: driving gear, 30: tool holder, 31: motion converting mechanism, 33: striking mechanism, 35: rotation transmitting mechanism, 36: intermediate shaft, 40: motor body, 41: motor shaft, 42: pinion gear, 54: clutch mechanism, 55: driving sleeve, 56: gear sleeve, 60d, 60n, 60h: switch, 61: indicating part, 61d, 61n, 61h: LED lamp, 65: stopper, 66: front end surface, 67: rear end surface, 70: connecting member, 71: first member, 72: second member, 73: third member, 74: engagement arm, 76: connection pin, 77: torsion spring, 90: mode detecting part, 91: first switch, 92: second switch, 95: acceleration sensor, 100: rotary hammer, 101: tool accessory, 122: upper surface, 123: motor case, 132: rear wall, 170: grip part, 171: switch lever, 172: main switch, 173, 174: connection part, 175, 176: elastic member, 177: opening, 178: locking projection, 180: lock lever, 181: body, 182: locking piece, 184: lock hole, 301: lock ring, 311: crank shaft, 312: driven gear, 313: connecting rod, 315: piston, 317: cylinder, 331: striker, 333: impact bolt, 335: air chamber, 361: small bevel gear, 362: driven gear, 551: annular groove, 561: large bevel gear, 711: plate-like part, 712: rack gear, 713: right projection, 714: left projection, 717: first projection, 718: second projection, A1: driving axis, A2: rotational axis, A3: rotational axis, Pd: position, Ph: position

1. A power tool having a rotary hammer mechanism, comprising:
a first motor that is housed in a tool body;
a driving mechanism that is configured to operate by power of the first motor in an action mode that is selected from a plurality of action modes including a first mode of at least rotationally driving a tool accessory around a driving axis and a second mode of only linearly driving the tool accessory along the driving axis;
a tool holder that is configured to removably hold the tool accessory and to be rotationally driven around the driving axis by torque transmitted from the first motor;
a second motor;
a clutch member that is configured to be moved, by power of the second motor, to a transmitting position where the clutch member enables torque transmission to the tool holder and to an interrupting position where the clutch member interrupts the torque transmission to the tool holder; and
a transmitting mechanism that is configured to convert rotation of the second motor into linear motion and transmit the linear motion to the clutch member,
wherein:
the second motor is configured to be driven:
to change the action mode of the driving mechanism to the first mode by moving the clutch member to the transmitting position via the transmitting mechanism, and to change the action mode of the driving mechanism to the second mode by moving the clutch member to the interrupting position via the transmitting mechanism, and
to move the clutch member from the transmitting position via the transmitting mechanism when the tool body excessively rotates around the driving axis.

2. The power tool as defined in claim 1, wherein:
the clutch member is on the tool holder and configured to be movable along the driving axis,
the transmitting position and the interrupting position are different positions in a direction along the driving axis, and
the transmitting mechanism is configured to convert the rotation of the second motor into the linear motion along the driving axis and transmit the linear motion to the clutch member.

3. The power tool as defined in claim 1, further comprising:
a rotation detecting part that is configured to detect a state of rotation of the tool body around the driving axis; and
a controlling part that is configured to control driving of the first motor and the second motor,
wherein:
the controlling part is configured to:
determine whether the tool body is excessively rotated around the driving axis based on a detection result of the rotation detecting part, and
stop driving of the first motor and drive the second motor to move the clutch member from the transmitting position in response to determining that the tool body is excessively rotated around the driving axis.

4. The power tool as defined in claim 1, further comprising a mode detecting part that includes a first detecting part configured to detect that the action mode of the driving mechanism is the first mode and a second detecting part configured to detect that the action mode of the driving mechanism is the second mode.

5. The power tool as defined in claim 3, further comprising:
a mode detecting part that includes a first detecting part configured to detect that the action mode of the driving mechanism is the first mode and a second detecting part configured to detect that the action mode of the driving mechanism is the second mode,
wherein:
the controlling part is configured to stop the second motor based on a detection result of the mode detecting part.

6. The power tool as defined in claim 2, further comprising:
a stopper,
wherein:
the transmitting mechanism includes a first member that is operably coupled to the second motor and to the clutch member and that is configured to be moved along the driving axis by the second motor, and
the stopper is configured to position the clutch member in the transmitting position or in the interrupting position by interfering with the first member.

7. The power tool as defined in claim 6, wherein:
the first member is movable in a first direction and a second direction opposite to the first direction in parallel to the driving axis,
the stopper has a first surface and a second surface that cross the moving direction of the first member,
the first surface positions the clutch member in the transmitting position by interfering with the first member when the first member moves in the first direction, and the second surface positions the clutch member in the interrupting position by interfering with the first member when the first member moves in the second direction.

8. The power tool as defined in claim 2, wherein:
a rotational axis of the second motor extends in a direction crossing the driving axis, and
the driving axis extends through the second motor.

9. The power tool as defined in claim 8, wherein the transmitting mechanism includes a pinion gear that is rotated by the second motor, and a rack gear that is configured to be engaged with the pinion gear and convert rotation of the pinion gear into the linear motion along the driving axis.

10. The power tool as defined in claim 1, further comprising:
a main operation member that is configured to be normally held in an OFF position and to be moved to an ON position to drive the first motor when manually depressed by a user;
a locking member that is configured to be moved to a lock position to lock the main operation member in the ON position or to a non-lock position not to lock the main operation member in the ON position, in response to the user's manual operation of the locking member; and
a lock controlling member that is configured such that:
(1) when the first mode is selected, the lock controlling member is in a position to interfere with the locking member, thereby holding the locking member in the non-lock position,
(2) when the second mode is selected, the lock controlling member is in a position not to interfere with the locking member, thereby allowing the locking member to move to the lock position.

11. The power tool as defined in claim 1, further comprising:
a rotation detecting part that is configured to detect a state of rotation of the tool body around the driving axis;
a handle having a grip part that extends in a direction crossing the driving axis and is configured to be held by a user; and
an elastic member that connects the handle to the tool body so as to be movable along the driving axis relative to the tool body,
wherein:
the rotation detecting part is housed within the handle.

12. The power tool having as defined in claim 1, further comprising:
a mode changing operation part that is configured to be manually operated by a user to select the action mode of the driving mechanism,
wherein:
the mode changing operation part is an electronic switch that is arranged such that there is no gap between the electronic switch and an outer surface.

13. The power tool as defined in claim 12, wherein the second motor is configured not to be driven while the first motor is driven.

14. The power tool as defined in claim 1, further comprising an indicating part that is configured to indicate the action mode of the driving mechanism.

15. The power tool as defined in claim 2, further comprising:
a rotation detecting part that is configured to detect a state of rotation of the tool body around the driving axis; and
a controlling part that is configured to control driving of the first motor and the second motor,
wherein:
the controlling part is configured to:
determine whether the tool body is excessively rotated around the driving axis based on a detection result of the rotation detecting part,
stop driving of the first motor and drive the second motor to move the clutch member from the transmitting position in response to determining that the tool body is excessively rotated around the driving axis.

16. The power tool as defined in claim 15, further comprising a mode detecting part that includes a first detecting part configured to detect that the action mode of the driving mechanism is the first mode and a second detecting part configured to detect that the action mode of the driving mechanism is the second mode.

17. The power tool as defined in claim 16, wherein the controlling part is configured to stop the second motor based on a detection result of the mode detecting part.
